(19) United States
(12) Patent Application Publication
(10) Pub. No.: US 2006/0018479 A1
(43) Pub. Date: Jan. 26, 2006

(54) Update method for wireless system of vehicle security system

(76) Inventor: Ying-Nan Chen, Kangshan Chen (TW)

Correspondence Address: DELLETT & WALTERS, P. O. BOX 82788, PORTLAND, OR, 97282-0788, US

(21) Appl. No.: 10/916,092

(22) Filed: Aug. 9, 2004

(30) Foreign Application Priority Data
Jun. 29, 2004 (TW) 093118921

(51) Int. Cl. H04K 1/00

(52) U.S. Cl. 380/270

(57) ABSTRACT

An update method for a wireless system of a security system for a vehicle is mainly applied for a vehicle security system to build a two-way connection with a remote host. After the remote host acquires a two-way connection with the security system, new system data is divided into a plurality of packets and sent to the security system sequentially. When the security system has received all of the packets, the complete new system data is taken out to process the system update of the vehicle security system. Therefore, a security system monitored by a remote host is installed in the vehicle. By the remote host processing the system update, the vehicle need not for recall by a vehicle manufacturer, as so to achieve an update objective rapidly and conveniently.

### BACKGROUND OF THE INVENTION

1. Field of the Invention

The invention relates in general to an update method for a vehicle security system, and more particularly to an update method with a wireless communication channel for a vehicle security system.

2. Description of the Related Art

In many countries, private car ownership is steadily increasing and thus more and more people are gradually spending greater amounts of time in the cars. Technological advances, such as radar, Global Positioning Systems, alarm systems have transformed use of cars and have provided great convenience, especially in safety and security. Therefore, integrating the modern technology products with the vehicles undoubtedly provides more convenient and user-friendly services to drivers.

Along with such a technological trend and rising personal security awareness, vehicle manufacturers and security firms now work together to provide state of the art monitoring of vehicles. Installations of the vehicles built with vehicle security services include at least the car burglar alarms and wireless communication modules. By the burglar alarms checking abnormal conditions of the vehicle, signals are transmitted to a remote host of the vehicle manufacturers or the security service firms via the wireless communication module, so that the vehicle manufacturers or the security service firms can monitor the vehicle.

However, the vehicle manufacturers encounter a problem for the above-mentioned vehicles equipped with wireless security installations. The remote host needs a close cooperation of external security installations of the vehicles to finish programs update or modification due to a need for modifying system programs or update management or monitor programs. To sum up, the system of the security installations needs to be updated to be consistent with the update monitor programs of the remote host. A conventional method is that the vehicle manufacturers recall the vehicles to update the system of the security installations of the vehicle in an appropriate manner.

Although the above update procedure for a vehicle security system does not impact operations of the vehicle a lot, most drivers are not ready to go back to the vehicle manufacturer for system update. Therefore, the conventional vehicle burglarproof system certainly fails to provide timely and convenient update solutions.

### SUMMARY OF THE INVENTION

In view of the above-mentioned drawbacks, it is therefore an object of the present invention to provide a wireless update method for a vehicle security system whereby the security system can be updated without need for the vehicle to be recalled.

According to an object of the present invention, a main technical method of an update method is to provide a security system installed with a wireless communication module. The update method comprises:
sending a system update command from the remote host;
the security system reading the system update command through the wireless communication module;
the security system confirming whether to prepare for a system update procedure or not, and calling the remote host so as to set up a mutual connection; and
building a two-way connection between the remote host and the security system to execute a transmission procedure of system data.

Accordingly, the present invention can exactly execute the wireless update for the security system installed in the vehicle without need for recall by a car manufacturer to execute system update by manual operation. Therefore, the present invention is very convenient.

According to another object of the present invention, an update method to ensure data transmission accuracy is provided. The remote host calculates a confirmation bit of checking data bit accuracy for every packet and includes the confirmation bit in the packet. Since the wireless communication module in the vehicle uses the common communication protocol, the confirmation bit can be used to check the accuracy of the packet data while receiving every packet. If an error occurs for the confirmation bit of the packet, an error message is sent instantly to the remote host, so as to stop sending the sequential packets. At this moment, a reconnection with the security system can be chosen to redo the system update procedure. Therefore, the present invention can ensure the processor of the security system updates the system data accurately.

Furthermore, the present invention also provides a wireless update method having a second checking procedure for the system data accuracy. Accordingly, after the wireless communication module receives all of the packets, all of the confirmation bits are drawn out to execute a certain operation to ensure that the received packet data is correct, and then the received packet data is inputted to the security system to execute the system update by the processor.

### BRIEF DESCRIPTION OF THE DRAWINGS

FIG. 1 shows a system framework block diagram of executing an embodiment of a present invention.

FIG. 2 shows a technological processes sequence diagram of completing system updating of a preferred embodiment of the present invention.

FIG. 3 shows a technological processes sequence diagram of unfinished system updating of a preferred embodiment of the present invention.

FIG. 4 shows an instance diagram of the embodiment of the present invention in the FIG. 1.

### DETAILED DESCRIPTION OF THE INVENTION

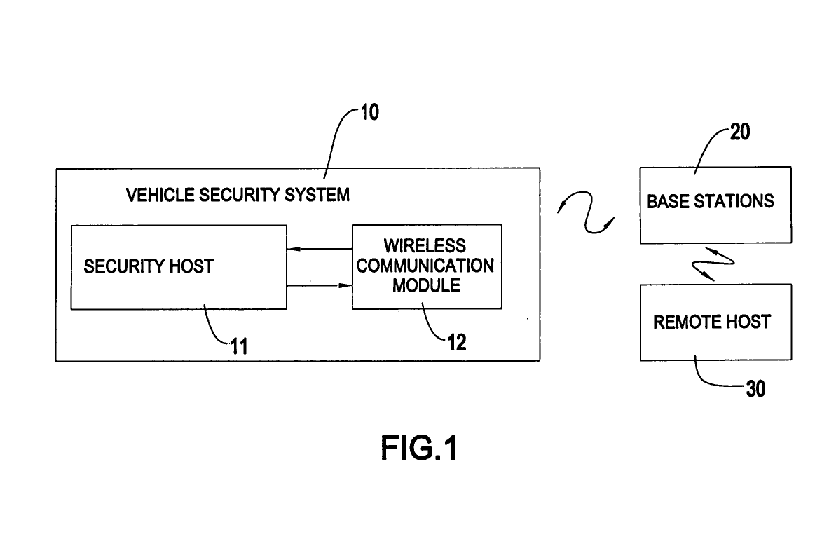

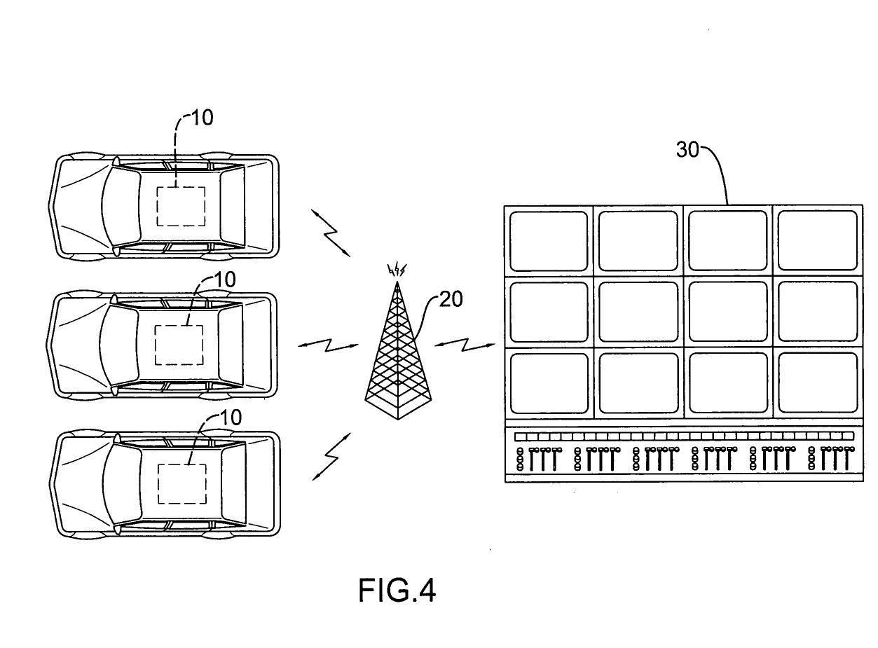

Referring to FIG. 1 and FIG. 4 firstly, a hardware device constructed with a wireless update method of a preferred embodiment of the present invention is shown. The present invention includes a vehicle security system 10. Moreover, the present invention mainly includes a security host 11 and a two-way connection wireless communication module 12 for connecting with the security host 11. The security host 11 integrates a Global Positioning System (GPS) module. After the wireless communication module 12 connects with base stations 20, a mutual connection with a remote host 30 is acquired whereby the remote host 30 acquires data of the vehicle security system 10 successfully. Accordingly, the present invention of the wireless update method is constructed base on a system connection framework. Further, the wireless update method includes the steps as follows:
the remote host sends a system update command;
while the security system in the vehicle reads the system update command sent by the remote host with the wireless communication module, the security system starts to confirm whether to prepare for a system update procedure or not, and to call the remote host after finishing confirming, so as to set up a mutual connection; and
wherein after the remote host acquires a call signal of the security system, a two-way connection with the security system is built and starts to execute a transmission procedure of system data; wherein the transmission procedure includes:
the remote host executing a packet division for the new system data and sending packets to the security system in the vehicle in sequence, wherein the new system data is processed as a plurality of packets having a confirmation bit in every packet, wherein the confirmation bit is obtained by executing a logical operation for the partial system data of the packets;
the security system of the vehicle receiving the packets from the remote host, and checking with the confirmation bit signal of every packet, so as to ensure that bit data of the packets is exactly correct during transmission; and then sending a completion receiving signal to the remote host after finishing receiving and checking all packets, and starting to update system, while on the other hand, the remote host recording that the vehicle has finished data updating.

If any packet data is error during transmission, the security system sends an error message to the remote host, and then the remote host stops sending the sequential packets and ends the system update procedure.

Furthermore, after the security system completes receiving all accurate packets, according to the present invention, the complete system data and all confirmation bits are further taken out to double-check the accuracy of the complete system data. According to the foregoing description of the method, it is found that the remote host 30 actually plays a role of a call center communicating with each security host 11 of the vehicle to perform update procedure. The detailed interaction between the remote host 30 and the security host 11 is disclosed hereinafter.

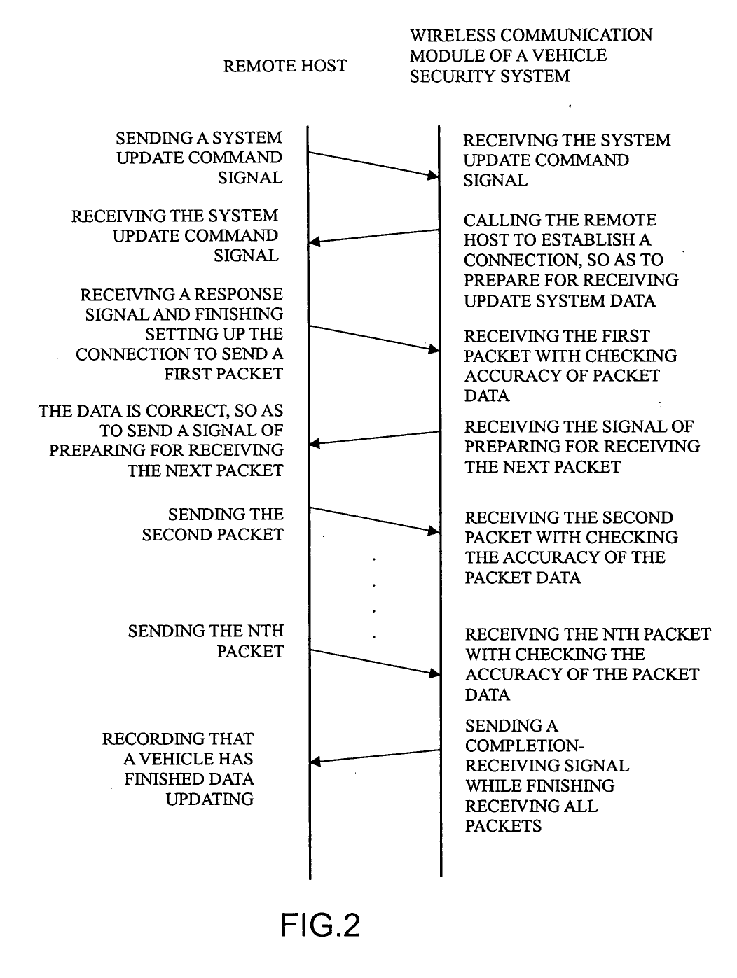

Referring to FIG. 1 and FIG. 2 simultaneously, a successful system update procedure is shown. The remote host 30 has built-in a large quantity of vehicle data. When starting to update the system, the remote host 30 connects with the vehicle security system 10 of a specific vehicle via the base stations 20 one by one. A technological processes sequence diagram of the remote host 30 executing system updating for a vehicle security system 10 of a preferred embodiment of the present invention is shown in FIG. 2.

Firstly, the remote server 30 sends a system update command signal to the security system 10. After the wireless communication module 12 of the vehicle security system 10 receives the system update command signal, the system update command signal is inputted to a processor of the security host 11, which is not shown in the figure. Then the processor determines whether to respond to the remote server or not. When the processor determines to accept the system update, a call server signal is outputted via the wireless communication module 12, so as to set up a two-way connection with the remote server 30. After the remote server 30 receives the call signal, the two-way connection is established. Accordingly, the remote server 30 starts to divide the new system data into a plurality of packets having the confirmation bit in every packet, and then sends to the vehicle security system 10.

When the vehicle security system 10 receives the first packet, the confirmation bit is taken out. Since the confirmation bit is acquired by the logical operation for the packet data, the vehicle security system 10 can check the accuracy of the packet data according to the confirmation bit. Due to some of the bit error may occur while transmitting the packets, the confirmation step by checking with the confirmation bit can ensure reception of correct system data. Thereby the packets are repeatedly sent and received until all packets are received by the security system 10.

When the security system has received all the packets completely and checked without finding any error, a completion-receiving signal is sent to the remote server. After the remote host receives the completion-receiving signal of the security system, the remote host records that the vehicle has finished system updating. The disclosed method above of the preferred embodiment of the present invention can further be applied for more than one vehicle at the same time to process the connections and updating.

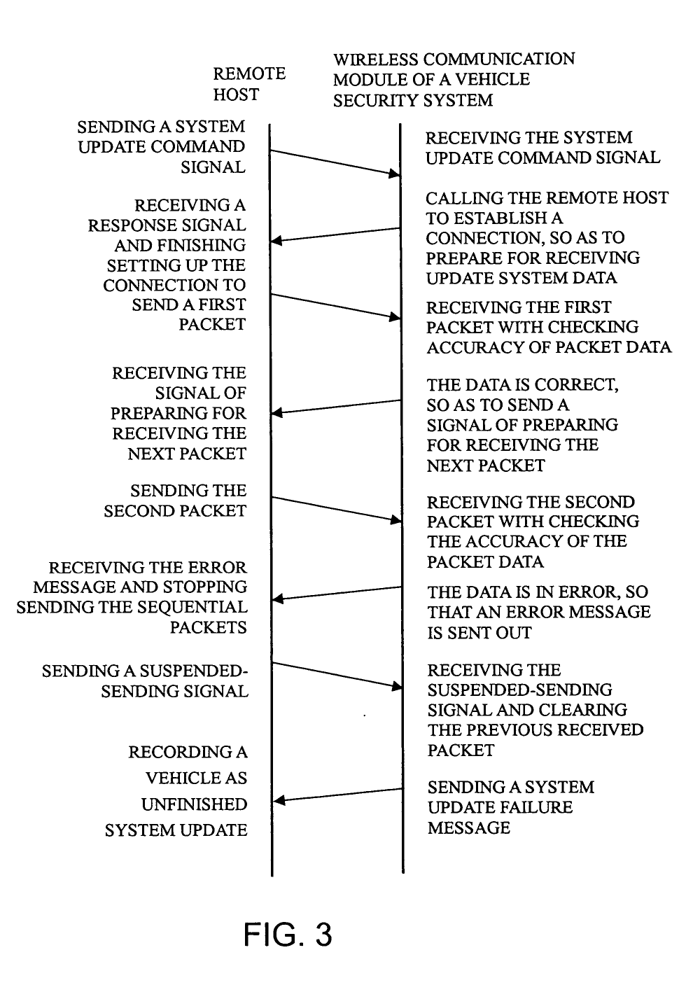

Moreover, referring to FIG. 3, a technological processes sequence diagram of an unfinished system updating which sends a system update failure message of a preferred embodiment of the present invention is shown. Simultaneously, firstly a remote host sends a system update command to the security system to set up a two-way connection with the security system. After the connection is established, the remote host starts to divide new system data into a plurality of packets having a confirmation bit in every packet. Then the packets are sent to the vehicle security system in sequence.

The confirmation bit of the packet is taken out to check the accuracy of the packet bit data when the vehicle security system receives the first packet. If the confirmation bit is correct after checking, a signal of preparing for receiving the next packet is sent, and simultaneously, the remote host sends the next packet promptly. On the contrary, if the packet data changes bit data due to poor connection quality, so as to result in an error while the security system checks the confirmation bit with the accuracy of the bit data of the packets, the security system then sends an error message to the remote server. While the remote host receives the error message, the remote host immediately stops sending the sequential packets and outputs a suspended-sending signal to the security system. At this moment, the security system clears the previous received system data and does not process system update. Then a system update failure message is further sent back to the remote host, and the remote host records the vehicle as unfinished system update, and disconnects the connection with the security host. If the system update is desired to proceed, the remote host must request reconnection with the security system, so as to repeat the above-mentioned system update procedures. In addition, the preferred embodiment of the present invention also can apply by other designs that choose to discard the error packet data during transmission, and then send the correct packets to the vehicle security system again. Thereby the disconnection of system update due to the packet errors can be prevented, so as to provide the other solution of the preferred embodiment of the present invention.

Therefore, the above-mentioned method illustrates the preferred embodiment of the present invention. The present invention achieves the objective of the update method for the wireless system by connecting the security system with the remote host, so as to facilitate the owner to update the system without need for manufacturer recall. To sum up, the present invention is really very convenient and is very beneficial for development of security and security services of remote vehicles.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An update method for a wireless system of a vehicle security system (10) for a vehicle, wherein the vehicle security system (10) comprises a security host (11) and a wireless communication module (12) for a two-way connection of the security host (11) and a remote host (30), wherein the update method for the wireless system comprises:
sending a system update command from the remote host (30);
the security system (10) reading the system update command through the wireless communication module;
the security system (10) confirming whether to prepare for a system update procedure or not, and calling the remote host (30) so as to set up a mutual connection; and
building a two-way connection between the remote host (30) and the security system (10) to execute a transmission procedure of system data.

2. The update method for the wireless system of the security system for the vehicle as claimed in claim 1, wherein the transmission procedure comprises:
the remote host (30) executing to divide a plurality of packets of the new system data and sending the packets to the security system (10) in the vehicle in sequence, wherein the new system data is processed as the plurality of packets and prepared to be sent to the security system (10) in the vehicle;
the security system (10) receiving all the packets from the remote host (30), and sending a completion receiving signal to the remote host (30) and starting to update the system; and
the remote host (30) recording that the vehicle has finished data updating.

3. The update method for the wireless system of the security system for the vehicle as claimed in claim 2, wherein the step of the remote host (30) processing all packets is to generate a confirmation bit according to packet data, wherein the confirmation bit is included in the packets; and wherein every time the security system (10) receives the packets from the remote host (30), the confirmation bit is drawn out to check accuracy of the packet data; if finding that any one of the packets is error, an error message is sent to the remote host (30), whereby the remote host (30) stops sending the sequential packets and disconnects with the security system (10).

4. The update method for the wireless system of the security system for the vehicle as claimed in claim 3, wherein the confirmation bit of all of the packets is obtained by a specific logic operation of the packet data.

5. The update method for the wireless system of the security system for the vehicle as claimed in claim 3, wherein the security system completes receiving all of the accurate packets, and the complete system data and all confirmation bits are further taken out to double-check the accuracy of the complete system data.

6. The update method for the wireless system of the security system for the vehicle as claimed in claim 4, wherein the security system completes receiving all of the accurate packets, and the complete system data and all confirmation bits are further taken out to double-check the accuracy of the complete system data.

7. The update method for the wireless system of the security system for the vehicle as claimed in claim 1, wherein the security host (11) further integrates with a Global Positioning System (GPS) module.
